(19) United States
(12) Patent Application Publication
(10) Pub. No.: US 2007/0091593 A1
(43) Pub. Date: Apr. 26, 2007

(54) Positionable flashlight with dual light sources

(75) Inventors: Michael Krieger, Miami Beach, FL (US); Kevin Ellsworth, Alva, FL (US)

Correspondence Address: VECTOR PRODUCTS, INC.;ROBERT POWELL, P.O. BOX 34385, c/o VENABLE LLP, WASHINGTON, DC, 20043-9998, US

(73) Assignee: Vector Products, Inc., Fort Lauderdale, FL (US)

(21) Appl. No.: 11/261,761

(22) Filed: Oct. 31, 2005

Related U.S. Application Data
(63) Continuation of application No. 29/239,437, filed on Sep. 30, 2005, now Pat. No. D526076.

(51) Int. Cl. F21L 4/00

(52) U.S. Cl. 362/157

(57) ABSTRACT

The flashlight comprises a housing defining a recess therein. The light sources are disposed in the housing. A first light source is fixably attached to the housing. The first light source is preferably arranged at a front end of the housing. A second light source is arranged in the recess. The second light source is adapted to pivot and extend from the recess. The second light source preferably extends longitudinally along the length of the housing. The recess may extend through the housing such that light from the second light source projects from opposite sides of the housing when the second light source is disposed within the recess.

This application claims priority from U.S. patent application Ser. No. 29/239,437, filed on Sep. 30, 2005, which is incorporated herein by reference.

### BACKGROUND OF THE INVENTION

### Field of the Invention

The present invention relates generally to flashlights and more particularly to multi-function flashlights.

Flashlights, and especially hand-held flashlights are used in many instances as first sources of light in locations which are situated too far for the use of light sources connected to an electric power distribution network, or in which locations the distribution network has failed. Flashlights typically provide only a single light source. As such, these flashlights only have one mode of operation.

Many flashlights are not capable of hands free use. The flashlight cannot be supported or positioned such that a user can use both hands and still be supplied with light. Also, in many instances, the single light source may be inadequate for a situation, for example, the light may be too bright, not bright enough, focused over too large or too small an area, etc.

Thus, there is a need for a multi-function flashlight that overcomes the above-described problems. Such a flashlight would desirably include different light sources that can be used in different situations, as well light sources that can be arranged in different positions.

### Summary of the Invention

Embodiments of the invention provide a flashlight. The flashlight may comprise a housing having a top surface and a bottom surface, the housing defining a recess therein extending from the top surface to the bottom surface; a first light source disposed in the housing; a second light source disposed in the recess, the second light source having a first end and a second end, the first end being pivotably attached to the housing within the recess such that the second light source is moveable between a first position in which the first and second ends are arranged within the recess and a second position in which the second end is outside the recess.

### BRIEF DESCRIPTION OF THE DRAWINGS

The foregoing and other features and advantages of the invention will be apparent from the following, more particular description of an exemplary embodiment of the invention, as illustrated in the accompanying drawings wherein like reference numbers generally indicate identical, functionally similar, and/or structurally similar elements.

FIG. 1 is a perspective view of a flashlight according to an exemplary embodiment of the present invention;

FIG. 2 is a top view of the flashlight shown in FIG. 1; and

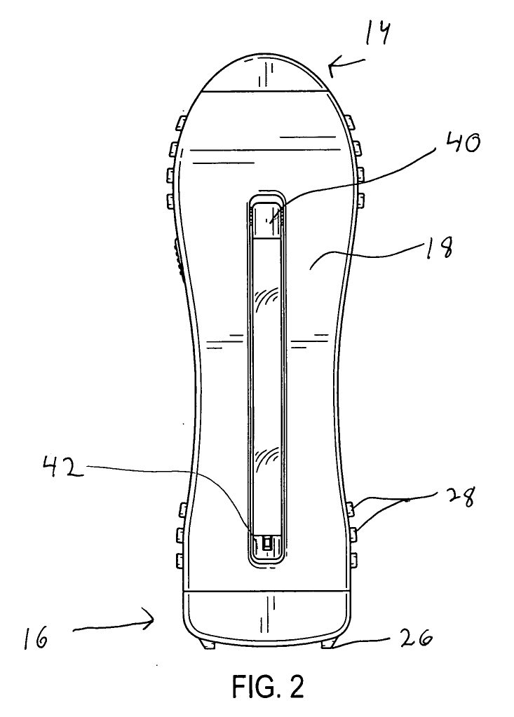

FIG. 3 is a perspective view of the flashlight shown in FIG. 1 with a second light source in an extended position.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

Embodiments of the present invention are directed to a flashlight with two or more light sources. The flashlight comprises a housing defining a recess therein. The light sources are disposed in the housing. A first light source is fixably attached to the housing. The first light source is preferably arranged at a front end of the housing. A second light source is arranged in the recess. The second light source is adapted to pivot and extend from the recess. The second light source preferably extends longitudinally along the length of the housing. The recess may extend through the housing such that light from the second light source projects from opposite sides of the housing when the second light source is disposed within the recess. The first and second light sources may comprise one or more lamps, such as incandescent bulbs, light emitting diodes (LEDs), fluorescent lamps, etc.

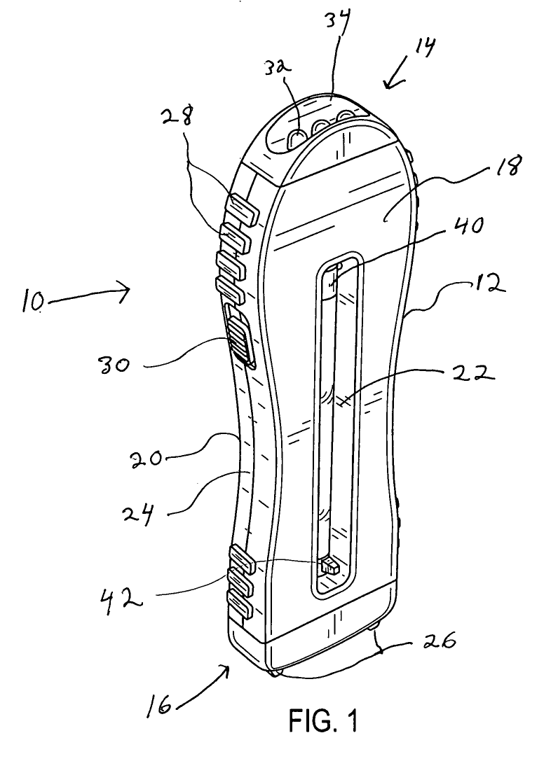

FIG. 1 illustrates an exemplary embodiment of a flashlight according to the present invention. The flashlight includes a housing 12. The housing 12 includes a first end 14, second end 16, a top surface 18 and bottom surface 20. A recess 22 is defined in the housing 12. A side surface 24 extends around the housing 12 connecting the top and bottom surfaces 18, 20. The recess 22 preferably extends completely through the housing 12. For example, the recess 22 may form an opening from the top surface 18 of the housing 12 to the bottom surface 20 of the housing 12, although variations in the recess size and shape are also envisioned. In the embodiment shown, the recess 22 extends longitudinally along the housing 12.

The second end 16 of the housing 12 may be adapted to support the housing 12 on end. Projections 26 that support the flashlight, for example on a tabletop or the like, may be provided at the second end 16 of the housing 12. The side surface 24 of the housing 12 may be contoured to ergonomically fit in a user's hand. Additionally, grips 28 may be provided on the housing 12 to help the user hold the flashlight.

The housing 12 may enclose a power source and other electronic circuitry (not shown) needed to power and control the flashlight as is known to one of ordinary skill in the art. The second end 16 of the housing 12 may be detachable to provide access to the power source or other components within the housing 12.

A power controller 30 may be disposed on the housing 12. The power controller 30 may be a multi-position switch used to control the operation of the first and second light sources. The switch may be positionable in a first position in which the first light source is illuminated, in a second position in which the second light source is illuminated, in a third position in which both light sources are illuminated, and in a fourth position which is the off position. Of course, other types of power switches or positions may be provided depending on the specific implementation. For example, it may be desirable to control the illumination of individual LEDs comprising the first light source.

The first light source may be arranged at the first end of the housing 12. The first light source may include one or more LEDs. A lens 32, reflector (not shown), and lens cover 34 may also be provided as is known in the art. The first light source is preferably fixed within the first end 14 of the housing 12. For example, as shown in FIG. 1, the first light source is disposed in the side surface 24.

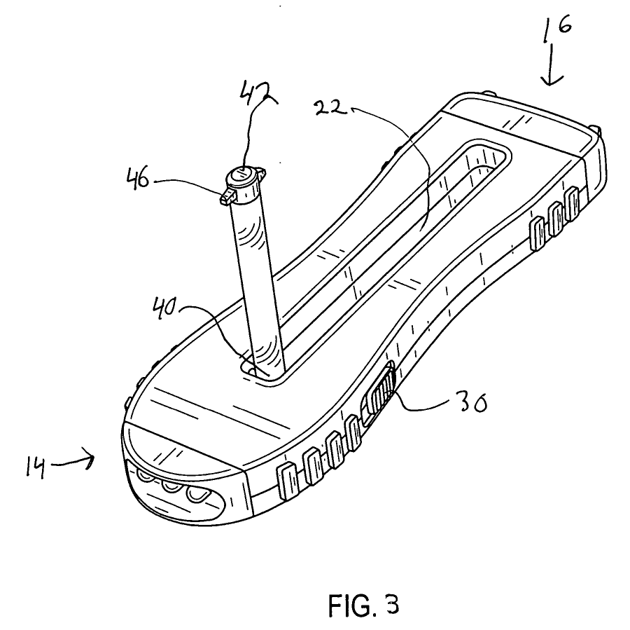

The second light source, which may be a cold cathode fluorescent light (CCFL), may be disposed at least partially within the recess 22. The second light source extends longitudinally in the recess 22. The second light source may be pivotably attached to the housing 12. The second light source may pivot to extend from the housing 12 as is shown in FIG. 3. For example, the CCFL as illustrated includes a first end 40 and a second end 42. The first end 40 of the CCFL is arranged in the recess 22 and is pivotably attached to the housing 12. For example, the CCFL may be attached to the housing 12 via hinges, pins extending from the first end 40 into corresponding holes in the housing 12, or the like. The second end 42 of the CCFL may be moved from within the recess 22 and the CCFL pivoted about its first end 40 to project from the housing 12, as shown in FIG. 3. The second end 42 of the CCFL may include a protrusion 46. A user may grasp or push the protrusion 46 to move the CCFL from the recess 22 and pivot the CCFL about its first end 40. The second end 42 of the CCFL may or may not be removeably coupled to the housing 12, for example, snap fit into the recess.

FIG. 1 shows the CCFL in a first position disposed within the recess 22. In the first position, both the first and second ends 40, 42 of the CCFL are arranged within the recess 22. In this position, the CCFL can project light both from the top surface 18 and from the bottom surface 20 of the housing 12. However, light is not projected from the side surfaces 24 of the flashlight.

In the second position, the CCFL is pivoted out of the recess 22. In the embodiment shown in FIG. 3, the CCFL extends substantially perpendicular from the housing 12 when fully extended. In the second position, the CCFL may disperse light radially. The CCFL may be held in the second position, for example via the hinges or other mechanism. Additionally, the CCFL may be held in various positions between the first and second positions. In some embodiments the CCFL may be configured to extend to a position beyond perpendicular to the housing. The flashlight may be balanced to stand on second end even when the second light source extends from the recess.

The flashlight may be supported by the housing in several different positions. As shown in FIG. 1, the flashlight 10 may stand on the second end 16. The second light source projects light from both the top and bottom surfaces 18, 20 of the housing 12 in this position. The flashlight 10 may also be supported on either the top or bottom surface 18, 20 of the housing 12. For example, as is shown in FIG. 3, the flashlight can be supported on a surface, such as a table, by the bottom surface 20.

By arranging the second light source within a recess in the housing, the flashlight maintains a slim profile. Also, the flashlight can project light radially when the second light source is moved from the recess. The second light source may be pivotable in either direction through the recess. This allows the flashlight to be supported on either the top surface or the bottom surface when the second light source is moved to the second position.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A flashlight comprising:
a housing having a top surface and a bottom surface, the housing defining a recess therein extending from the top surface to the bottom surface;
a first light source disposed in the housing;
a second light source disposed in the recess, the second light source having a first end and a second end, the first end being pivotably attached to the housing within the recess such that the second light source is moveable between a first position in which the first and second ends are arranged within the recess and a second position in which the second end is outside the recess the second end of the second light source is moveable beyond either the top or bottom surface of the housing.

2. The flashlight of claim 1, wherein the recess extends longitudinally along the top and bottom surfaces of the housing.

3. The flashlight of claim 1, wherein the first light source comprises at least one light emitting diode (LED) and the second light source comprises a cold cathode fluorescent light (CCFL).

4. The flashlight of claim 1, further comprising a hinge pivotably attaching the first end of the second light source to the housing.

5. The flashlight of claim 1, wherein the second light source projects light radially from the housing when in the second position.

6. The flashlight of claim 1, wherein the second light source is pivotable in two directions beyond either the top or bottom surface of the housing.
